(19) United States
(12) Patent Application Publication
(10) Pub. No.: US 2006/0004485 A1
(43) Pub. Date: Jan. 5, 2006

(54) Fuel pump island vending

(76) Inventor: Mark B. Thomas, Andover, MN (US)

Correspondence Address: SCHWEGMAN, LUNDBERG, WOESSNER & KLUTH, 1600 TCF TOWER, 121 SOUTH EIGHT STREET, MINNEAPOLIS, MN, 55402, US

(21) Appl. No.: 10/882,480

(22) Filed: Jul. 1, 2004

(51) Int. Cl. G06F 17/00

(52) U.S. Cl. 700/232

(57) ABSTRACT

Some embodiments include a fuel and product dispensing apparatus comprising a fuel dispenser and product dispenser within a housing providing the ability to purchase one or more of fuel, products, and services in a single transaction. Other embodiments include a product dispenser adapted for mounting to a fuel dispenser, such as a gas pump, providing consumers the ability to purchase products in a transaction along with fuel. Some embodiments further comprise conductively coupling the product dispenser to the fuel dispenser to equalize an electrical potential to reduce electrostatic discharges.

### TECHNICAL FIELD

The inventive subject matter relates to vending machines and, more particularly, to systems and method for fuel pump island vending.

### BACKGROUND

Many gas stations are arranged for consumers to pump fuel and pay for pumped fuel inside a building also including a convenience store. These convenience stores provide consumers with an array of products such as drinks, candy, cigarettes, and various other products. However, since the introduction of fuel dispensers, commonly referred to as gas or fuel pumps, including point-of-sale terminals, sales of convenience store items have declined. This decline in sales is generally related to decreased traffic from consumers paying for fuel at the pump and leaving the station without entering the convenience store.

Previous attempts to reclaim lost sales attributable to consumers paying at the pump have included providing the ability to use an interface on a fuel pump to purchase products in a transaction along with fuel. Such systems operate by prompting a consumer if he or she would like to purchase other products. If the consumer chooses to purchase other products, some attempts prompt consumers to select desired products on an interface that is part of the fuel pump. Some attempts then print a receipt that is used by either taking the receipt into a store to pick up purchased items or entering a code printed on the receipt into a vending machine. Another attempt includes sending a signal to a vending machine remote to the fuel pump causing the vending machine to dispense the purchased products.

These attempts to reclaim lost sales have failed for many reasons including a complicated interface for consumers to navigate and a lack of space on fuel pump islands for vending machines. Further, attempts requiring consumers to enter a convenience store to pick up purchased items defeats the convenience of paying at the pump.

### BRIEF DESCRIPTION OF THE DRAWINGS

FIG. 1 illustrates an apparatus according to an example embodiment of the inventive subject matter.

FIG. 2 illustrates an apparatus according to an example embodiment of the inventive subject matter.

FIG. 3 illustrates an apparatus according to an example embodiment of the inventive subject matter.

FIG. 4 illustrates a system according to an example embodiment of the inventive subject matter.

FIG. 5 is a flow diagram of a method according to an example embodiment of the inventive subject matter.

FIG. 6 is a flow diagram of a method according to an example embodiment of the inventive subject matter.

FIG. 7 is a flow diagram of a method according to an example embodiment of the inventive subject matter.

FIG. 8 is a flow diagram of a method according to an example embodiment of the inventive subject matter.

### DETAILED DESCRIPTION

In the following detailed description, reference is made to the accompanying drawings that form a part hereof, and in which is shown by way of illustration specific embodiments in which the inventive subject matter may be practiced. These embodiments are described in sufficient detail to enable those skilled in the art to practice them, and it is to be understood that other embodiments may be utilized and that structural, logical, and electrical changes may be made without departing from the scope of the inventive subject matter. Such embodiments of the inventive subject matter may be referred to, individually and/or collectively, herein by the term “invention” merely for convenience and without intending to voluntarily limit the scope of this application to any single invention or inventive concept if more than one is in fact disclosed.

The following description is, therefore, not to be taken in a limited sense, and the scope of the inventive subject matter is defined by the appended claims.

The functions or algorithms described herein are implemented in hardware, software or a combination of software and hardware in one embodiment. The software comprises computer executable instructions stored on computer readable media such as memory or other type of storage devices. The term “computer readable media” is also used to represent carrier waves on which the software is transmitted. Further, such functions correspond to modules, which are software, hardware, firmware, or any combination thereof. Multiple functions are performed in one or more modules as desired, and the embodiments described are merely examples. The software is executed on a digital signal processor, Application-Specific Integrated Circuit (ASIC), microprocessor, or other type of processor operating on a system, such as a fuel pump, vending machine, personal computer, server, a router, or other device capable of processing data including network interconnection devices.

Some embodiments implement the functions in two or more specific interconnected hardware modules or devices with related control and data signals communicated between and through the modules, or as portions of an ASIC. Thus, the exemplary process flows are applicable to software, firmware, and hardware implementations.

The present inventive subject matter includes embodiments of various arrangements of apparatuses and methods for vending products in conjunction with fuel. Some embodiments include product dispensers integrated within fuel dispensers while other embodiments include product dispensers to mount to fuel dispensers. Various embodiments include methods for processing a total cost comprising dispensed products and fuel in a single transaction. These embodiments and others are described below and illustrated in the accompanying figures.

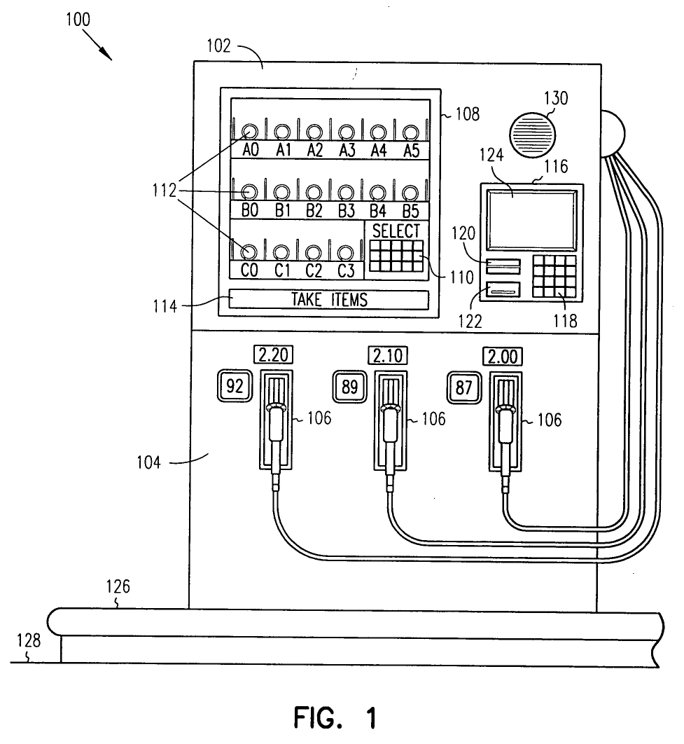

FIG. 1 illustrates an apparatus 100 according to an example embodiment of the inventive subject matter. The apparatus 100 comprises a fuel dispenser 104, a product dispenser 108, and a controller 116 integrated within a housing 102. In some embodiments, the apparatus is installed on a fuel pump island 126. In some embodiments, the apparatus 100 includes a mirror image of itself on an opposite side providing an apparatus 100 allowing for fuel and product transactions from opposite sides of a fuel pump island 126.

In various embodiments, the controller 116 includes a keypad 118, a bankcard reader 120, a receipt printer 122, and a display 124. The controller 116, in various embodiments, further includes circuitry, software, or circuitry and software for performing various functions. Some such functions include receiving and processing payment information, activating the fuel dispenser 104 and the product dispenser 108, displaying an amount of fuel dispensed and a cost therefore, displaying information about products selected from the product dispenser, and collecting transaction data to determine a transaction total for dispensed fuel and products. The controller 116, in some embodiment, is capable of performing various other tasks or processes depending on the requirements of a specific embodiment.

In some embodiments, the bankcard reader 120 of the controller 116 is a credit card reader. In some embodiments, the bankcard reader 120 is either supplemented or replaced by another device such as a radio frequency (RF) receiver (not shown). In some RF embodiments, the RF receiver is capable of receiving signals from a radio frequency identification device (RFID). In some embodiments, the RFID device includes its own power source to transmit an RF signal. In other embodiments, the RF receiver broadcasts a signal causing an RFID to respond. A signal received by the RF receiver includes a customer identifier to bill a transaction total to a customer account.

The display 124, in various embodiments, includes a cathode ray tube, a liquid-crystal display, a digital display, or virtually any other display type capable of displaying text or images. In some embodiments, the display 124 is a touch screen display. In some touch screen display embodiments, a keypad 118 is not included in the controller 116.

In some embodiments, the controller 116 controls operation of at least a portion of the apparatus 100. For example, the controller 116, upon receipt of customer information, activates the fuel dispenser 104 and the product dispenser 108. In some embodiments, the information includes payment information. In some embodiments, the fuel dispenser 104 and the product dispenser 108 are both activated upon receipt of acceptable payment information. In some embodiments, payment information is electronically communicated to a financial institution for validation prior to activating the fuel dispenser 104 and product dispenser 108. Other embodiments include receiving currency at the controller 116.

Some embodiments of the controller further include an audio output (not shown) to connect to a speaker 130. Other embodiments include a speaker 130 integrated within the controller 116.

In some embodiments of the controller 116 including an audio output and a speaker 130, upon activation of the fuel dispenser 104 and product dispenser 108, one or more messages are output from the speaker 130 encouraging a customer to select products from the product dispenser 108. In some embodiments of the controller 116, video is output from the display 124 encouraging a customer to select products from the product dispenser 108. In yet further embodiments, audio and video are output from the speaker 130 and the display 124 encouraging a customer to select products from the product dispenser 108.

In some embodiments, the controller 116 encourages a customer to select products from the product dispenser 108 based on various factors. In such an embodiment, factor information is received by the controller and customer encouragements are selected based on the factor information. For example, in an embodiment including a temperature factor, customers are encouraged to select cold drinks from product dispenser 108. Other factors includes sale items, product dispenser 108 inventory, time of day, or virtually any factor for encouraging customers to purchase products.

In some embodiments, the fuel dispenser 104 includes one or more fuel nozzles 106, each nozzle to dispense a type of fuel. The operation and components of the fuel dispenser are well known to those of ordinary skill in the art of fuel dispensing apparatuses and will not be further described for the sake of brevity.

In some embodiments, the product dispenser 108 includes one or more product holders 112, a pickup point 114 to receive selected products, and a product selection device 110 to select products. In some embodiments, the product dispenser includes a cooling device for refrigerating products within the product dispenser 108. In some embodiments, the product dispenser is activated by the controller 116 upon receipt of customer information, such as payment information. In some embodiments, the controller 116 provides an indicator to a customer that the product dispenser 108 is activated for use. In some embodiments, the indicator is displayed on the display 124 of the controller 116. In other embodiments, the indicator includes turning on a light or other indication device on or within the product dispenser 108.

In various embodiments, the product dispenser 108 is adapted to dispense canned, bottled, boxed, and packaged goods and beverages. Some such products include soft drinks, candy, chips, and personal items. In some embodiments, the personal items include lip balm, sun screen, breath strips, and virtually any other product in a form, or packaged in a form, capable of being dispensed from the product dispenser.

In some embodiments, the product selection device 110 is a keypad. The keypad includes various keys for entering a code corresponding to a product holder 112. Entry of a code on the keypad in such an embodiment causes the product dispenser 108 to dispense a product from a product holder 112 corresponding to a received input code. Some other embodiments include a product selection device 110 including a button for each product in the product dispenser 108. Upon product selection, some embodiments include sending a signal to the controller 116 to cause the controller 116 to add a cost of the selected product to a transaction total. Some embodiments include storing selected product data until a later time, such as when fueling is complete, and then sending the selected product data to the controller 116.

In some embodiments, the product dispenser 108 includes all electrical current carrying devices at least eighteen inches above grade 128. Other embodiments that include electrical current carrying devices less than eighteen inches above grade include explosion containment systems as required by various jurisdictions. Electricity flowing to the product dispenser, in some embodiments, is carried on wires within metal conduit. The characteristics of the conduit varies depending on requirements of various jurisdictions.

In some embodiments, the housing 102 of the apparatus 100 includes conductive connections between the various components to equalize electric potential between the components. In some such embodiments, the interconnection of the various components is further grounded to facilitate electrical potential dissipation. The electrical potential in some cases is electrostatic and is approximately equalized between the components, such as the fuel dispenser 104 and the product dispenser 108 via the interconnection. The electrostatic charge is then dissipated via the ground (not shown).

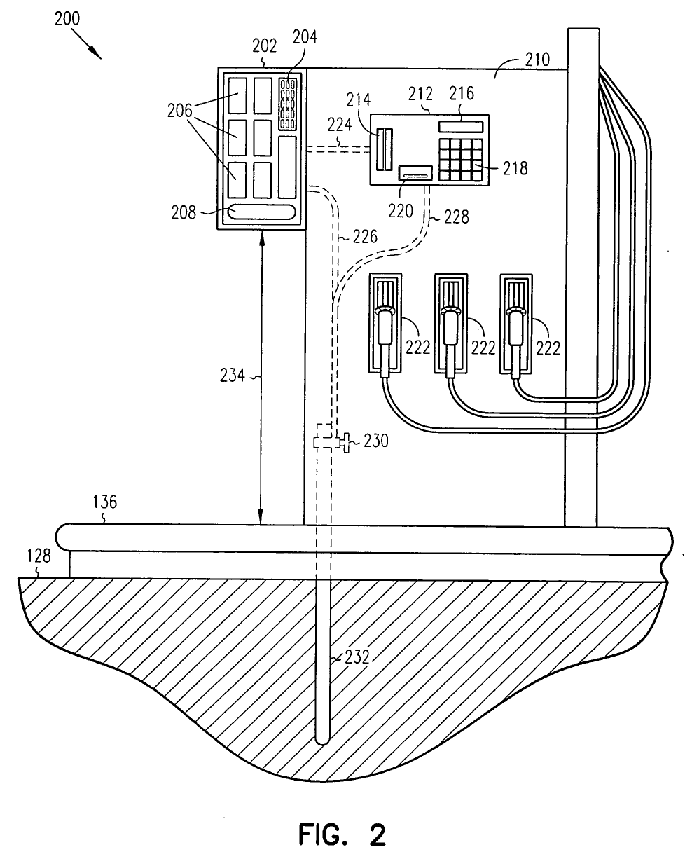

FIG. 2 illustrates an apparatus 200 according to an example embodiment of the inventive subject matter. The apparatus 200 includes a product dispenser 202 mounted to a fuel dispenser 210, commonly referred to as a gas pump. The apparatus 200 in some embodiments is bolted, or otherwise mounted, to a fuel pump island 126. In some embodiments, the fuel pump island is three inches above grade 128. In various other embodiments the fuel pump island 126 is five inches, six inches, seven inches, or another distance above grade 128 depending on local code, regulations, statutes, or custom.

Some embodiments include a two-sided fuel dispenser 210 providing the ability to conduct fueling transactions on opposite sides of a fuel pump island 126. Some embodiments include two product dispensers 202 mounted to the fuel dispenser 210 providing the ability to purchase products on each side of the fuel dispenser 210.

In some embodiments, the fuel dispenser 210 includes fuel dispensing nozzles 222 and a controller 212. In some embodiments, the controller 212 includes a bankcard reader 214, a display 216, a keypad 218, and a receipt-printing device 220. The controller 212 is of a type generally found on fuel dispensers allowing customers to pay for gas at the pump. The operation of the controller 212 is generally the same with regards to controlling the fuel dispenser 210. However, the controller 212 is adapted to interface with the product dispenser 202. The adaptation of the controller 212 in various embodiments is achieved by communicatively coupling 224 the controller 212 to the product dispenser 202.

The communicative coupling 224 between the controller 212 and the product dispenser 202 allows the controller 212 to activate the product dispenser 202 for dispensing goods upon activation of the fuel dispenser 210. Further, signals from the product dispenser 202 corresponding to products selected or dispensed from the product dispenser 202 are communicated to the controller over the communicative coupling 224. The controller upon receipt of signals corresponding to the selected or dispensed goods are added to a transaction total that also includes a cost of fuel dispensed from the fuel dispenser 210. When a transaction is complete, the controller 212 communicates a signal over the communicative coupling 224 causing the product dispenser 202 to deactivate.

The controller 212, in various embodiments, further includes circuitry, software, or circuitry and software for performing various functions. Some such functions include receiving and processing payment information, activating the fuel dispenser 210 and the product dispenser 202, displaying an amount of fuel dispensed and a cost therefore, displaying information about products selected from the product dispenser, and collecting transaction data to determine a transaction total for dispensed fuel and products. The controller 212, in some embodiments, is capable of performing various other tasks or processes depending on the requirements of a specific embodiment. Some such tasks include selling services such as car washes, oil changes, or other products and services not capable of being dispensed from the product dispenser 202.

In some embodiments, the product dispenser 202 is mounted to the fuel dispenser 210 to include all electrical current carrying devices at least eighteen inches above grade 128. Some embodiments include mounting the product dispenser 202 to provide a clearance 234 under the product dispenser equal to eighteen inches minus the height of the fuel pump island 126. Other embodiments include mounting the product dispenser to the fuel dispenser 210 at least three feet above grade 128.

Some embodiments of mounted product dispensers 202 that include electrical current carrying devices less than eighteen inches above grade include explosion containment systems as required by various jurisdictions. Electricity flowing to the product dispenser 202, in some embodiments, is carried on wires within metal conduit. The characteristics of such conduit varies depending on requirements of various jurisdictions.

In some embodiments, the product dispenser 202 includes one or more product displays 206, a pickup point 208 to receive selected products, and a product selection device 204 to select products. In some embodiments, the product dispenser 202 includes a cooling device for refrigerating products within the product dispenser 202. In some embodiments, the product dispenser 202 is activated by the controller 212 upon receipt of customer information, such as payment information. In some embodiments, the controller 212 provides an indicator to a customer that the product dispenser 202 is activated for use. In some embodiments, the indicator comprises an indication on the display 216 of the controller 212. In other embodiments, the indicator includes turning on a light or other indication device on or within the product dispenser 202.

In various embodiments, the product dispenser 202 is adapted to dispense canned, bottled, boxed, and packaged goods and beverages. Some such products include soft drinks, candy, chips, and personal items. In some embodiments, the personal items include lip balm, sun screen, breath strips, and virtually any other product in a form, or packaged in a form, capable of being dispensed from the product dispenser 202.

In some embodiments, the product selection device 204 is a keypad. The keypad includes various keys for entering a code corresponding to a product display 206. Entry of a code on the keypad in such an embodiment causes the product dispenser 202 to dispense a product corresponding to an input code. Some other embodiments include a product selection device 204 including a button for each product in the product dispenser 202. Upon product selection, some embodiments include sending a signal to the controller 212 to cause the controller 212 to add a cost of the selected product to a transaction total. Some embodiments include storing selected product data until a later time, such as when fueling is complete, and then sending the selected product data to the controller 212.

In some embodiments, the apparatus 200 includes conductive connections, such as conductive ground connectors 226 and 228, between the controller 212, fuel dispenser 210, and the product dispenser 202 to equalize electric potential between the components. In some such embodiments, the interconnection of the various components is further grounded to facilitate electrical potential dissipation through a ground 232. The electrical potential in some cases is electrostatic and is approximately equalized between the components via the conductive ground connectors, such as 226 and 228, coupled 230 to the ground 232.

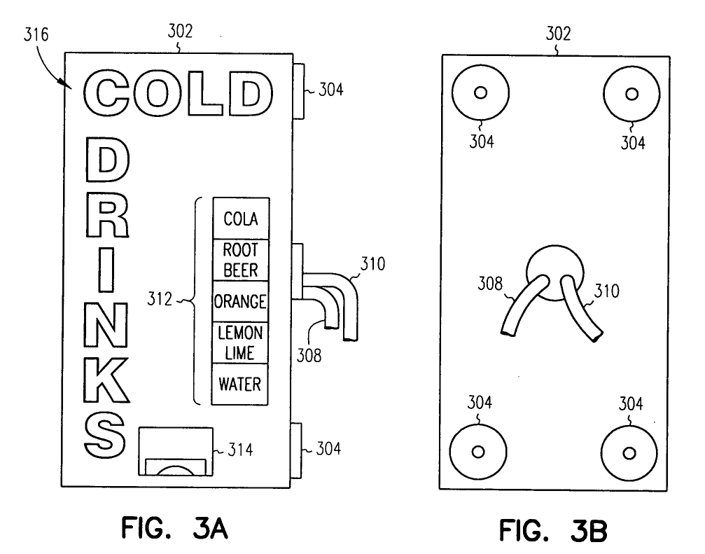

FIG. 3 illustrates an apparatus 302 according to an example embodiment of the inventive subject matter. The apparatus 302 is a product dispenser capable of mounting to a another device, such as a fuel dispenser, including a payment processing device, such as a point-of-sale terminal that accepts credit cards, currency, coupons, or other methods of payment.

In some embodiments, the apparatus 302 includes at least one attachment mechanism 304, a conductive ground connector 308, and a connector 310 capable of carrying signals between the apparatus 302 and a point-of-sale terminal of another device. The apparatus 302 further includes a product selection device 312, a product pickup point 314, and a marquee 316.

In some embodiments, the attachment mechanism 304 includes one or more bolting points for mounting the apparatus 302 to another device such as a fuel dispenser or pump. Some embodiments include four attachment mechanisms 304. The actual number of attachment mechanisms 304 required depends on a variety of factors including the weight of the apparatus 302 when loaded with products, the environment, the strength of the attachment mechanisms 304, and the strength of the device the apparatus 302 is mounted to. In some embodiments, the attachment mechanisms 304 are bolting points for receiving a bolt. Other embodiments of the attachment mechanisms 304 comprise an adhesive such as a glue or epoxy.

In embodiments of the apparatus including the conductive ground connector 308, the conductive ground connector 308 is connected to various components within the apparatus capable of holding, receiving, or generating an electrical potential, such as an electrostatic charge. The conductive ground connector 308 is capable of connection to a device the apparatus 302 is mountable upon. In some embodiments, the conductive ground connector 308 is connected to a ground of the device. The conductive ground connector 308, when coupled to the device approximately equalizes electrical potential between the devices, reducing risk of electrostatic discharge (ESD).

In some embodiments, the connector 310 capable of carrying signals between the apparatus 302 and a point-of-sale terminal of a device the apparatus is mountable to includes a serial communication cable capable of carrying data. In other embodiments, the connector 310 is virtually any other device or connection capable of carrying a signal between the apparatus 302 and a point-of-sale terminal or other transaction device for receiving a cost of dispensed goods from apparatus 302.

The product selection device 312 in some embodiments, includes a number of buttons equal to a number of product caches for holding dispensable products. In other embodiments the product selection device 312 is a keypad for entering a code corresponding to a product cache of the apparatus. In some embodiments, the keypad is also useful for entering a number corresponding to a quantity of a product desired from a particular product cache.

In various embodiments, the apparatus also includes a product pickup point 314 and a marquee 316. In some embodiments, the marquee 316 is a sign indicating the types of products available from the apparatus. In other embodiments, the marquee 316 is clear to allow viewing of available products. In some embodiments, the marquee 316 includes a lighting mechanism. In some such embodiments, the lighting mechanism illuminates upon activation of the apparatus 302.

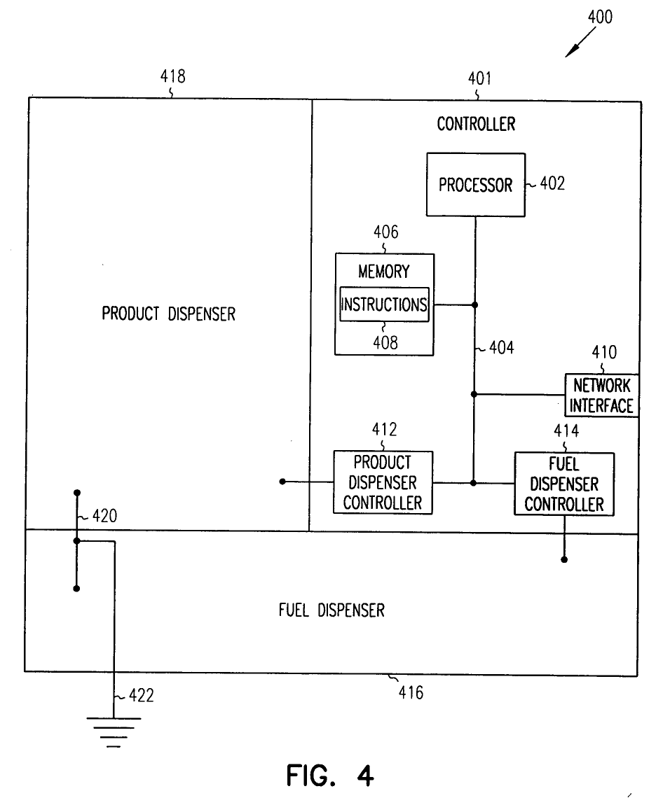

FIG. 4 illustrates a system 400 according to an example embodiment of the inventive subject matter. The system 400 includes a controller 401, a fuel dispenser 416, and a product dispenser 418. Some embodiments of the system 400 include a conductive coupling 420 between the product dispenser 418 and the fuel dispenser 416 to minimize risk of ESD between the components and from the system 400. In some embodiments, the conductive coupling 420 is further conductively attached to a ground 422. Some such embodiments facilitate dissipation of an electrostatic or other electrical charge.

In some embodiments, the controller 401 includes a processor 402, a memory 406, and a network interface 410 operatively coupled via a bus 404. In some embodiments, the controller 401 also includes a fuel dispenser controller 414 and a product dispenser controller 412 operatively coupled to the bus 404. However, other embodiments include the fuel dispenser controller 414 and the product dispenser controller 412 located within the fuel dispenser 416 and the product dispenser 418, respectively.

The memory 406 of the controller 401 includes instructions 408 executable by the processor 402. In some embodiments, the instructions 408, when executed, cause the system 400 to request an authorization from an authorizing entity over the network interface for a product and fuel purchase transaction. The instructions further cause the system to send activation signals to the fuel dispenser controller and the product dispenser controller upon receipt of the requested authorization. In some embodiments, the authorizing entity is a financial institution, such as a bank. In other embodiments, the authorizing entity is a clearing house entity for processing credit card authorizations and billing. In some embodiments, the memory 406 further includes instruction to process fuel and product purchase transactions, communicate transaction totals to the authorizing entity, and deactivate the fuel dispenser 416 and the product dispenser 418 upon completion of a transaction.

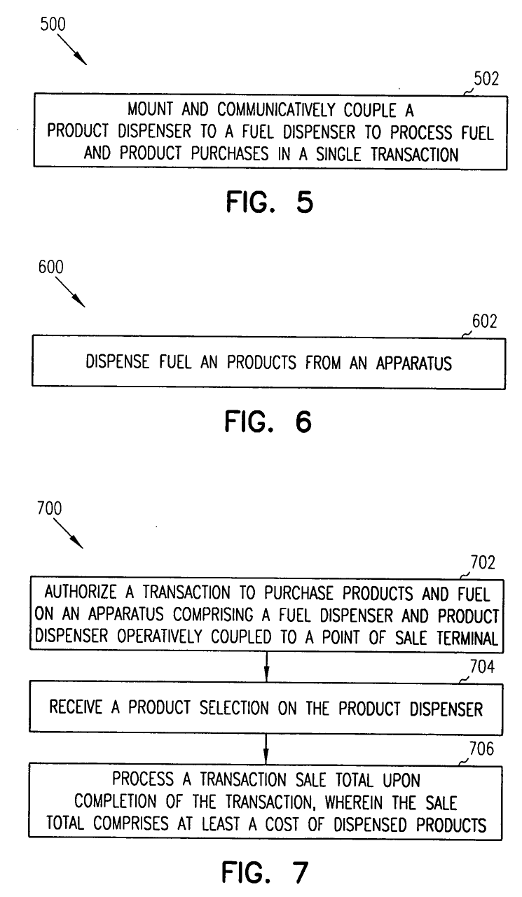

FIG. 5 is a flow diagram of a method 500 according to an example embodiment of the inventive subject matter. The method 500 includes mounting and communicatively coupling a product dispenser to a fuel dispenser to process fuel and product purchases in a single transaction 502.

In some embodiments of the method 500, the single transaction comprises requesting and receiving a transaction authorization from a third party, adding a cost of dispensed fuel and a cost of dispensed products to a transaction total and communicating the transaction total to the third party. In some embodiments, the third party is a financial institution. In various embodiments, a financial institution includes a bank, a credit union, or other institution or entity providing financial resources to a card holder. In other embodiments, the third party is a representative of a financial institution.

In some embodiments, mounting the product dispenser to the fuel dispenser comprises mounting the product dispenser at least eighteen inches above grade. In other embodiments, mounting the product dispenser to the fuel dispenser comprises mounting the product dispenser including electrical components a distance above grade as required by local code, regulation, ordinance, or custom.

In some embodiments, mounting the product dispenser to the fuel dispenser includes electrically coupling the product dispensing apparatus to the fuel dispenser to equalize an electrical potential between the product dispensing apparatus and the fuel dispenser. Some further embodiments include grounding the product dispenser to facilitate dissipation of an electrostatic charge to minimize or prevent ESD.

FIG. 6 is a flow diagram of a method 600 according to an example embodiment of the inventive subject matter. The method 600 includes dispensing fuel and products from an apparatus 602. Some embodiments further include processing a total cost of dispensed fuel and products in a single transaction.

In some embodiments of the method 600, the fuel and products are dispensed from an apparatus comprising a product dispenser and fuel dispenser located within a single housing. In other embodiments, the apparatus includes a product dispenser physically mounted to a fuel dispenser. In various embodiments, the product dispenser is mounted directly on top of, on the side of, in front of, or otherwise to a fuel dispenser.

FIG. 7 is a flow diagram of a method 700 according to an example embodiment of the inventive subject matter. The method 700 includes authorizing a transaction to purchase products and fuel on an apparatus comprising a fuel dispenser and product dispenser operatively coupled to a point-of-sale terminal 702 and receiving a product selection on the product dispenser 704. The method 700 further includes processing a transaction sale total upon completion of the transaction, wherein the sale total comprises at least a cost of dispensed products 706.

In some embodiments, authorizing a transaction to purchase products and fuel on an apparatus 702 comprises receiving payment information from a customer. In some embodiments, receiving payment information includes receiving customer input indicating the customer will pay at an attendant counter, such as inside a convenience store at a gas station where the apparatus is located. Other embodiments include receiving currency from the customer. Yet further embodiments include receiving bankcard information from a customer from a magnetic card reader that is part of a point-of-sale terminal operatively coupled or integrated within the apparatus. Some other embodiments further include receiving coupons or discount codes from a customer via a bar code reader or keypad.

After receipt of the payment information, the method 700 authorizes the transaction by verifying bankcard information with a third party, verify the amount of currency received, or verifying a discount or coupon amount or percentage. Upon receipt of verification, some embodiments then activate the apparatus. Activation of the apparatus includes activating the fuel dispenser and product dispenser to dispense fuel and products, respectively.

In some embodiments, receiving a product selection on the product dispenser 704 includes receiving a product selected using a product selection device. Some other embodiments include a product selection by an apparatus implementing the method for a promotional product. Such a promotion product, in some embodiments is automatically selected by the apparatus after a purchase of a certain amount, or combination, of other products. For example, upon purchase of a eight gallons of fuel, the apparatus may cause a soft drink to be dispensed from the product dispenser.

In some embodiments of the method 700, processing a transaction sale total upon completion of the transaction 706 includes printing a receipt. In various embodiments, the receipt includes one or more of a cost of dispensed fuel, a cost of dispensed products, a transaction sale total, and a tax amount, such as sales tax attributable to dispensed products. In some embodiments, the receipt includes a voucher or code for receiving one or more products or services not available, or out of stock on the apparatus.

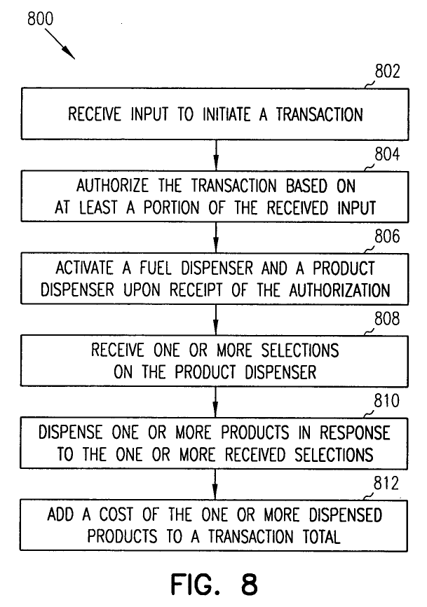

FIG. 8 is a flow diagram of a method 800 according to an example embodiment of the inventive subject matter. In some embodiments, the method 800 includes receiving input to initiate a transaction 802, authorizing the transaction based on at least a portion of the received input 804, and activating a fuel dispenser and a product dispenser upon receipt of the authorization 806. Some embodiments further include receiving one or more selections on the product dispenser 808, dispensing one or more products in response to the one or more received selections 810, and adding a cost of the one or more dispensed products to a transaction total 812. Some embodiments of the method 800 further include dispensing fuel and adding a cost of the dispensed fuel to the transaction total.

It is emphasized that the Abstract is provided to comply with 37 C.F.R. §1.72(b) requiring an Abstract that will allow the reader to quickly ascertain the nature and gist of the technical disclosure. It is submitted with the understanding that it will not be used to interpret or limit the scope or meaning of the claims.

In the foregoing Detailed Description, various features are grouped together in a single embodiment to streamline the disclosure. This method of disclosure is not to be interpreted as reflecting an intention that the claimed embodiments of the invention require more features than are expressly recited in each claim. Rather, as the following claims reflect, inventive subject matter lies in less than all features of a single disclosed embodiment. Thus, the following claims are hereby incorporated into the Detailed Description, with each claim standing on its own as a separate embodiment.

It will be readily understood to those skilled in the art that various other changes in the details, material, and arrangements of the parts and method stages which have been described and illustrated in order to explain the nature of this inventive subject matter may be made without departing from the principles and scope of the inventive subject matter as expressed in the subjoined claims.

What is claimed is:

1. An apparatus comprising:
a housing;
a fuel dispenser within the housing;
a product dispenser within the housing; and
a controller within the housing operably coupled to the fuel dispenser and the product dispenser, wherein the controller activates the fuel dispenser.

2. The apparatus of claim 1, wherein the controller activates the product dispenser upon receipt of information.

3. The apparatus of claim 2, wherein the information is payment information.

4. The apparatus of claim 1, wherein the controller includes a point-of-sale terminal.

5. The apparatus of claim 1, wherein the product dispenser is positioned within the housing to be at least eighteen inches above grade when the apparatus is installed.

6. The apparatus of claim 1, further comprising:
a refrigeration unit to cool products within the product dispenser.

7. The apparatus of claim 1 further comprising:
means for equalizing electrical potential between the housing, the fuel dispenser, the product dispenser, and the controller.

8. A product dispenser comprising:
an attachment mechanism to attach the product dispenser to a fuel dispensing pump;
a conductive ground connector;
a controller to control the operation of the product dispenser and interfacing with a payment processing-module of the fuel dispensing pump; and
a connector capable of carrying signals between the controller and the payment-processing module.

9. The product dispenser of claim 8, further comprising a product selection device.

10. The product dispenser of claim 9, wherein the product selection device comprises a button for each product position in the product dispenser.

11. The product dispenser of claim 8, wherein the conductive ground connector is couplable to a ground of the fuel dispensing pump to balance electrostatic potentials between the product dispenser and the fuel dispensing pump.

12. The product dispenser of claim 8, wherein the payment-processing module of the fuel dispensing pump comprises a credit card point-of-sale terminal.

13. The product dispenser of claim 8, wherein the controller activates the product dispenser upon receipt of an activation signal from the payment processing module.

14. The product dispenser of claim 13, wherein the activation signal is received by the controller when the fuel dispensing pump is activated to dispense fuel.

15. The product dispenser of claim 8, wherein the controller communicates a signal to the payment processing module upon receipt of a product selection.

16. The product dispenser of claim 15, wherein the signal communicated to the payment processing module includes a cost of the selected product.

17. The product dispenser of claim 8, wherein the product dispenser is attachable to the fuel dispensing pump to avoid increasing a foot-print of the fuel dispensing pump.

18. A fuel dispensing pump comprising:
a point-of-sale terminal to receive payment information, processing payments, and to generate an activation signal; and
a coupling point adapted to receive a product dispensing apparatus, wherein the coupling point comprises:
a mounting point to mount the product dispensing apparatus;
an electrical supply to power the product dispensing apparatus; and
a communication connection to communicatively couple the dispensing apparatus to the point-of-sale terminal.

19. The fuel dispensing pump of claim 18, wherein the activation signal from the point-of-sale terminal comprises a signal communicated to the communication connection to activate the product dispensing apparatus.

20. The fuel dispensing pump of claim 18, wherein a cost of items selected from the product dispensing apparatus is received by the point-of-sale terminal over the communication connection and added to a total cost of a fuel purchase transaction.

21. The fuel dispensing pump of claim 18, wherein the coupling point further comprises a conductive grounding point to ground the product dispensing apparatus.

22. The fuel dispensing pump of claim 21, wherein the conductive grounding point to ground the product dispensing apparatus is conductively connected to one or more grounds of the fuel dispensing pump.

23. The fuel dispensing pump of claim 18, wherein the coupling point is positioned on the fuel dispensing pump to position all electrical components of the product dispensing apparatus at least eighteen inches above grade.

24. The fuel dispensing pump of claim 18, wherein the coupling point is positioned on the fuel dispensing pump to position all electrical components of the product dispensing apparatus at least 36 inches above grade.

25. A method comprising:
receiving input to initiate a transaction;
authorizing the transaction based on at least a portion of the received input;
activating a fuel dispenser and a product dispenser upon receipt of the authorization;
receiving one or more selections on the product dispenser;
dispensing one or more products in response to the one or more received selections; and
adding a cost of the one or more dispensed products to a transaction total.

26. The method of claim 25, further comprising:
dispensing fuel; and
adding a cost of the dispensed fuel to the transaction total.

27. The method of claim 25, wherein the input to initiate the transaction is received on a point-of-sale terminal.

28. The method of claim 25, wherein receiving input to initiate a transaction comprises receiving bankcard information.

29. The method of claim 28, wherein the bankcard is a credit card.

30. A method comprising:
authorizing a transaction to purchase products and fuel on an apparatus comprising a fuel dispenser and product dispenser operatively coupled to a point-of-sale terminal;
receiving a product selection on the product dispenser; and
processing a transaction sale total upon completion of the transaction, wherein the sale total comprises at least a cost of dispensed products.

31. The method of claim 30, wherein processing a transaction sale total includes printing a receipt, the receipt comprising a cost of dispensed fuel, a cost of dispensed products, and a transaction sale total.

32. The method of claim 30, wherein authorizing a transaction to purchase of products and fuel comprises receiving currency.

33. The method of claim 32, wherein the currency is received by the apparatus.

34. A method comprising:
providing an gas pump at a gas station, the gas pump including:
a housing;
a fuel dispenser within the housing; and
a controller within the housing operably coupled to the fuel dispenser;
mounting a product dispenser to the gas pump; and
communicatively coupling the product dispenser to the gas pump to process fuel and product purchases in a single transaction.

35. The method of claim 34, wherein the single transaction comprises:
requesting and receiving a transaction authorization from a third party;
adding a cost of pumped fuel and a cost of dispensed products to a transaction total; and
communicating the transaction total to the third party.

36. The method of claim 35, wherein the third party is a financial institution.

37. The method of claim 35, wherein the third party is a representative of a financial institution.

38. The method of claim 34, wherein mounting the product dispenser to the gas pump comprises mounting the product dispenser at least eighteen inches above grade.

39. The method of claim 34, further comprising:
electrically coupling the product dispenser to the gas pump to equalize an electrical potential between the product dispenser and the gas pump.

40. An apparatus comprising a product dispenser conductively coupled to a fuel pump to equalize an electrostatic potential between the product dispenser and the fuel pump.

41. A system comprising:
a processor;
a fuel dispenser, the fuel dispenser including a controller coupled to the processor;
a product dispenser, the product dispenser mounted to the fuel dispenser, wherein the product dispenser and the fuel dispenser are conductively coupled to approximately equalize an electrostatic potential between the product dispenser and the fuel dispenser, wherein the product dispenser includes a controller coupled to the processor;
a network interface coupled the processor;
a system memory coupled to the processor, the system memory including instructions executable on the processor for causing the system to:
request an authorization from an authorizing entity over the network interface for a product and fuel purchase transaction, and
send activation signals to the fuel dispenser controller and the product dispenser controller upon receipt of the requested authorization.

42. A fuel pump including a product dispenser, wherein the product dispenser includes a product selection user interface.

43. The fuel pump of claim 42, wherein the product selection user interface comprises a keypad, wherein entry of a code corresponding to a product causes the product dispenser to dispense the product.

44. The fuel pump of claim 42, wherein the product dispenser is conductively connected to a ground of the fuel pump to equalize a potential between the fuel pump and the product dispenser.
